(19) United States
(12) Patent Application Publication
(10) Pub. No.: US 2017/0058184 A1
(43) Pub. Date: Mar. 2, 2017

(54) Controlled-Release Chemical Particulate Composition for Well Treatment

(71) Applicant: PfP Technology, LLC, Katy, TX (US)

(72) Inventors: James Lavene, Rockwall, TX (US); Mickey Callanan, Houston, TX (US); John Turner, Houston, TX (US)

(73) Assignee: PfP Technology, LLP, Katy, TX (US)

(21) Appl. No.: 14/819,053

(22) Filed: Aug. 27, 2015

(51) Int. Cl. C09K 8/524; C09K 8/528; E21B 43/26; E21B 43/04; E21B 43/08; C09K 8/54; E21B 37/06

(52) U.S. Cl. CPC C09K 8/524; C09K 8/54; C09K 8/528; E21B 37/06; E21B 43/04; E21B 43/08; E21B 43/26; C09K 2208/12; C09K 2208/26

(57) ABSTRACT

The present disclosure relates to a composition comprising an active chemical agent adsorbed into a non-water-soluble carrier composed, at least in part, of corn grit. The present composition is useful for inhibiting scale or other undesirable formations. The composition may be introduced into the target during the stimulation or production treatment of an oil or gas well. The composition may be formed by adsorbing a liquid chemical agent onto a solid substrate of corn-based material called corn grit. The crush resistance and liquid-insolubility of corn grit help enable the composition to release the treatment chemical into the well over time. The liquid chemical combined with the solid substrate can be used as a well treatment agent for scale inhibitors, corrosion inhibitors, surfactants, non-emulsifiers, halite inhibitors, wettability modifiers, paraffin and asphaltene inhibitors, and water and oil-soluble tracers.

### FIELD OF INVENTION

The present invention relates to a composition for oilfield well applications that provides a gradual release of a well treatment chemical, and methods of making and using the same. Specifically, the invention relates to an active chemical agent adsorbed into a non-water-soluble carrier comprising corn grit.

### BACKGROUND

During oil and gas well stimulation and production many changes occur within the equilibrium of the system which often lead to decreased well performance. Changes in temperature, pressure, flow regimes, and the introduction of fluid sources and chemicals foreign to the formation all have tendencies to create issues such as chemical build up and scaling which can affect well performance. The issues typically encountered are the creation of salt and scale formation, paraffin and asphaltene deposition, emulsion formation, water blocking, and corrosion.

Chemicals such as polyphosphates, polymers, and acids are often utilized to treat the issues that lead to decreased well performance The chemistries used are selected based on the specific problems that each well encounters. These agents are typically used as a preventative measure but can also be applied as a remediation method when unwanted chemical formation, deposition, or emulsions have occurred.

The common scale inhibitors can be classified as organic, which includes phosphates and salts thereof, and inorganic, which includes polymers and various acids. These inhibitors are often water-soluble and hydrophilic, however inhibitors may also be designed to be oil-soluble.

One disadvantage of the common chemicals used and their treatments is that they dissipate or spend in a relatively short interval thereby requiring follow-up treatments. Delayed release inhibitors have been designed by adding common liquid inhibitors to porous non-water soluble materials such as diatomaceous earth, ground walnut shells, and anhydrous silica. These inhibitors have demonstrated the ability to slow the release of the active inhibitor in oil and gas wells, leading to longer treatment intervals. Despite efforts to develop improved materials for non-water-soluble carriers, the same inhibitor carriers have been used for many years with little change or progress in the art.

The inventors have discovered that ground corn cob, particularly the woody ring portion of the plant, can be used as a carrier for well treatment chemicals when provided in accordance with the present disclosure. Although corn cob has been used as an absorbent for various non-oilfield applications such as pet bedding, a carrier for insecticides, and oil and grease removal, adaptation and use of corn cob for adsorbing and slow-releasing active chemical agents under the demanding circumstances of oilfield well stimulation was completely unknown and unexpected prior to the present invention.

### SUMMARY

The present disclosure relates to an oil or gas well-treating composition that adsorbs an active chemical agent into a non-water-soluble corn grit carrier. Corn grit is the particulate that results from grinding or milling corn cob, particularly the woody ring portion of the corn plant, in accordance with the present disclosure. The corn grit carrier is a natural material that provides a controlled release of the active chemical agent.

The active chemical agent can be one of any number of known chemical agents designed to inhibit scale formation, corrosion, emulsion formation, salt formation, clay swelling, fine migration, paraffin deposition and asphaltene deposition. The chemical agent can also be a biocide that inhibits biological growth, or a cross-link breaker or gel breaker. The corn grit carrier can be engineered to provide a controlled release of the active chemical agent over the course of a few months, a year, or longer. Providing controlled release over 12 months, for example, will provide continuous well treatment during the entire 12-month period. In a preferred embodiment, controlled release of the active chemical agent from the corn grit carrier is triggered when the composition comes into contact with water in the oil or gas well. In an alternate embodiment, controlled release of the active chemical agent from the corn grit carrier is triggered when the composition comes into contact with oil in the oil or gas well.

In another embodiment of the present disclosure, the composition can comprise two or more different chemical agents adsorbed into the same corn grit carrier. This embodiment is useful when two or more different treatments are desired for the same well, for example both scale inhibition and corrosion inhibition. In that example, one active chemical agent will be a scale inhibitor, and the other active chemical agent will be a corrosion inhibitor. This embodiment can be manufactured by first blending the two different active chemical agents as liquids in the same batch, and then adsorbing the blend into the corn grit carrier.

In yet another embodiment of the present disclosure, the composition can comprise two different active chemical agents adsorbed into two different carriers, respectively. Both carriers can be corn grit carriers or one carrier can be a corn grit carrier and the other carrier can be a different non-water-soluble particulate carrier. This embodiment can be made by first adsorbing each active chemical agent into its respective carrier separately, to form two separate modified particulates. The particulates are modified in the sense that the natural milled corn cob has been modified by the adsorption of the active chemical agent. The two modified particulates are then blended together.

The embodiments described above can be designed to provide wettability changes to a proppant pack and formation. The embodiments described can also be designed to lower the surface tension of water in an oil or gas well. The embodiments can also be designed to deliver water- and oil-soluble tracers to fractures. These embodiments can also be designed to suppress odors or malodors associated with the oil and gas well industries. These odors and malodors can be those associated with the particular active chemical agents adsorbed by the carrier, or other odors and malodors associated with other scale inhibitors, corrosion inhibitors, emulsion breakers, salt inhibitors, clay stabilizers, fine control agents, paraffin inhibitors, asphaltene inhibitors, and dispersants.

The present disclosure also relates to a method for inhibiting scale or providing some other chemical treatment in an oil or gas well by pumping into the well a composition comprising an active chemical agent adsorbed into a non-water-soluble carrier composed of corn grit. The composition can be delivered as part of a fracture stimulation or a re-fracturing operation and can be pumped into the well with a proppant and a fracturing fluid matrix. The composition can be delivered in a gravel pack operation, or as a pre-packed screen containing the composition.

### BRIEF DESCRIPTION OF DRAWINGS

FIG. 1 is a chart highlighting the controlled release of chemical agent from the composition in a system under a continuous flow of fluid. The figure shows the performance of the disclosed composition at a 1% by weight loading to sand.

FIG. 2 is a chart highlighting the controlled release of chemical agent from the composition in a system under a continuous flow of fluid. The figure shows the performance of the disclosed composition at a 0.5% by weight loading to sand.

FIG. 3 is a chart highlighting the controlled release of chemical agent from the composition in a system under a continuous flow of fluid. The figure shows the performance of the disclosed composition at a 0.2% by weight loading to sand.

FIG. 4 is a chart highlighting the disclosed composition's resistance to crushing under pressures typically experienced in a well, which is important for longevity and effectiveness of the well treatment.

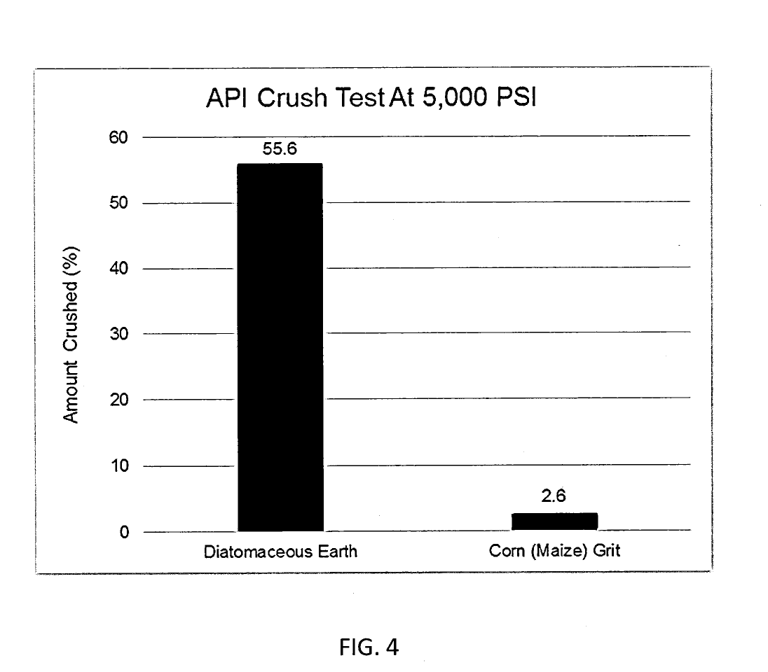

### DETAILED DESCRIPTION OF PREFERRED EMBODIMENTS

Embodiments of this disclosure relate to a composition active chemical agent and carrier material. The carrier material includes corn grit. One preferred active chemical agent for use in this composition is a scale inhibitor. In this preferred embodiment, the composition is intended for use in oil and gas wells to prevent or reduce the formation of chemical scale. The scale inhibition chemical is adsorbed onto the carrier material, which is then introduced into the well during stimulation treatment.

Further to this preferred embodiment, the composition releases the scale inhibition chemical in the presence of water once the material is placed in the well. The flow of fluid around the composition allows for the controlled release of scale inhibition chemical in an amount that is effective in controlling scale formation in oil and gas wells.

Oil and gas well scale may consist of a variety of chemical compositions including calcium carbonate, barium sulfate, gypsum, strontium sulfate, iron carbonate, iron oxides, iron sulfides, and magnesium salts. As such, the scale inhibitor chemical of this preferred embodiment may consist of acids and complexing agents known to inhibit the formation of such scale, such as inorganic polyphosphates, organic polyphosphates, ethylene diamine tetraacetic acid, polymers based on carboxylic acids, polyacrylates, phosphonic acid, and hydrochloric acid.

More specifically, the scale inhibitor chemical of this preferred embodiment may consist of one or more of the following compounds: 1-hydroxyethylidene-1,1-diphosphonic acid, carbonic dihydrazide, polyaminealkylphosphonic acid and carboxymethyl cellulose or polyacrylamide, polyacrylic acid and chromium, polyacrylates, amine methylene phosphonate, phosphonomethylated polyamine, sulfonated polyacrylate copolymer, bis[tetrakishydroxymethylphosphonium]sulfate, phosphonates, carboxymethyl inulin, polycarboxylic acid salts, phosphoric acid esters of rice bran extract, polyphosphino maleic anhydride, N,N-diallyl-N-alkyl-N-sulfoalkyl ammonium betaine copolymer (with N-vinylpyrrolidone or acrylamide (AAm)), diallylmethyltaurine hydrochloride, aminotrimethylenephosphonic acid, polyaspartates, polyacrolein, naphthylamine polycarboxylic acids, phosphonic acid and hydrofluoric acid, tertiary amines, diethylentrilopentrakismethylenephosphonic acid tetrakis hydroxyorgano phosphonium salts, phosphino-polycarboxylic acid, diethylentriaminepentaacetic acid, ethylene diamine tetraacetic acid, vinylsulfonate copolymer, phosphinated maleic copolymer.

The carrier agent of the preferred composition consists of corn grit, which is a corn (maize) based material. Corn grit is a portion of a milled or ground corn cob, particularly from the woody ring of the plant. Corn cob has the advantages of being naturally sourced and naturally non-liquid soluble, particularly non-water-soluble. The particle size of the corn grit in accordance with this preferred composition is from about a 10 mesh US standard sieve to about a 70 mesh US standard sieve. The surface area of the preferred corn grit is from about 0.005 m²/g to about 0.5 m²/g as measured by a standard BET gas adsorption. Other embodiments may have a surface area up to about 1 m²/g.

The corn grit of the preferred composition provides enhanced crush resistance when subjected to oil and gas well closure stresses. An American Petroleum Institute (API) standardized crush test showed that the corn grit of the present disclosure generated 2.6% fines at 5,000 psi. This is advantageous over, for example, the known well treatment carrier diatomaceous earth, which generated 55.6% fines under the same test conditions. Withstanding closure pressures allows the particulate to remain intact and not become pulverized. Pulverized particulate may flow back out of the well during production, which undermines the effectiveness of the controlled release formulation.

Preferred well treatment substances include scale inhibitors, corrosion inhibitors, salt inhibitors, paraffin inhibitors, gas hydrate inhibitors, asphaltene inhibitors, oxygen scavengers, biocides, antifoaming agents, emulsion breakers, crosslinkers, crosslinked gel breakers, friction reducers, clay stabilizers and surfactants. Examples of a preferred corrosion inhibitors are amides and imidazolines, polyoxylated amines, amides, salts of nitrogenous molecules with carboxylic acids, nitrogen quaternaries, and nitrogen heterocyclics. Examples of preferred salt inhibitors include acids and complexing agents such as inorganic polyphosphates, organic polyphosphates, ethylene diamine tetraacetic acid, polymers based on carboxylic acids, polyacrylates, phosphonic acid, and hydrochloric acid. Examples of preferred paraffin inhibitors include glycol esters, poly glycols, resin oxyalkylates, resin esters, diepoxide, polyacrylates, amine oxyalkylates, polyoxyalkylene glycols, nonylphenol ethopxylates, and alkylaryl sulfonates.

The preferred composition may be delivered to a well through a product such as a proppant or fluid carrier system. In such systems, the preferred composition represents between 0.2% to 25% of the total weight of the product delivered. The composition may be delivered during the stimulation treatment of the well. The composition may be pumped into the well with a carrier fluid system comingled with the proppant or alone. The composition is placed into the fractures of the well where it will release the active chemical agent or agents for one or more of the previously described purposes for an extended period of time during the production life of the well.

The corn grit carrier of the preferred composition also acts as an odor suppressant for strongly aromatic chemicals used in oilfield applications. Odor suppression has been qualitatively observed when creating a composition including the corn grit and certain malodorous oilfield chemicals.

### EXAMPLES

Example 1: Creating a preferred composition. A bag of raw corn grit is placed at the opening of the elevator. A total of 2,000 lbs. of corn grit is added into the elevator and placed into the paddle mixer. A total of 1,400 lbs. of ATMP is then pumped from a tote and into the paddle mixer. About half way through the pumping process the dust collector can be turned off if the material inside is damp enough to not allow dust to escape the paddle mixer. Mixing continues until the material inside becomes flowable. One end of a conveyor belt is placed underneath the paddle mixer and turned on. An empty bulk bag is placed at the other end of the conveyor belt and the valve at the bottom of the paddle mixer is opened. When the bulk bag is almost full the valve is shut off and the full bag is replaced with an empty one and so on and so forth until the mixer is empty. A full bulk bag of treated corn grit is placed at the opening of the elevator. The full bulk bags of material are added to the elevator and into the hopper above the shaker. An empty bulk bag is placed at the discharge of the shaker screen and the shaker is turned on. The valve at the bottom of the hopper is slightly opened. The flow of the material is kept at a volume so that material doesn't continue to grow in volume on the top scalping screen and blind it off. When the bulk bag is almost full the valve and the shaker are shut off and the full bulk bag is replaced with an empty one so that the hopper can be emptied through the shaker screen.

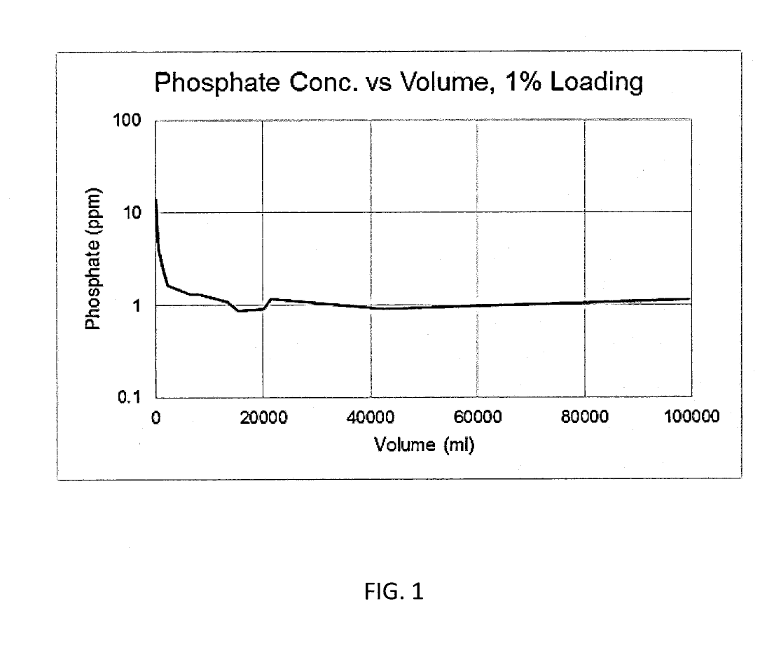

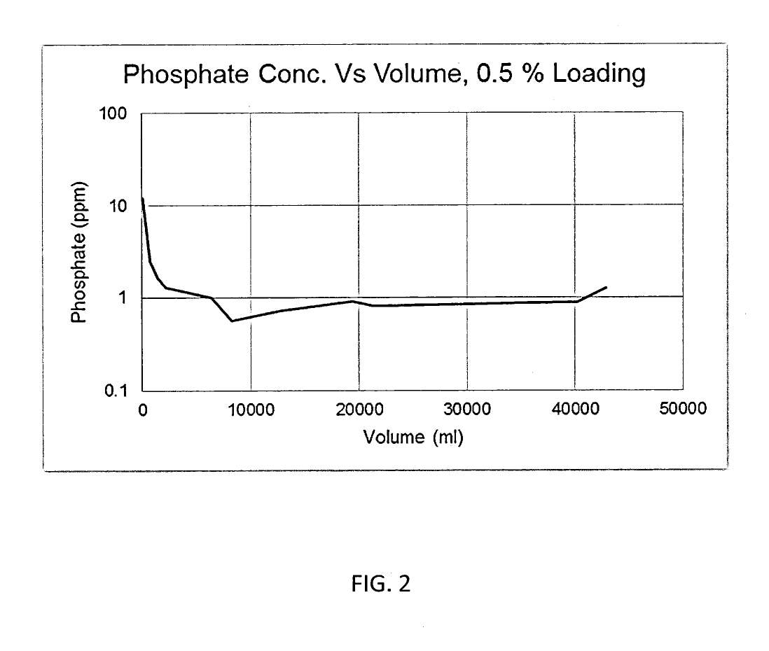

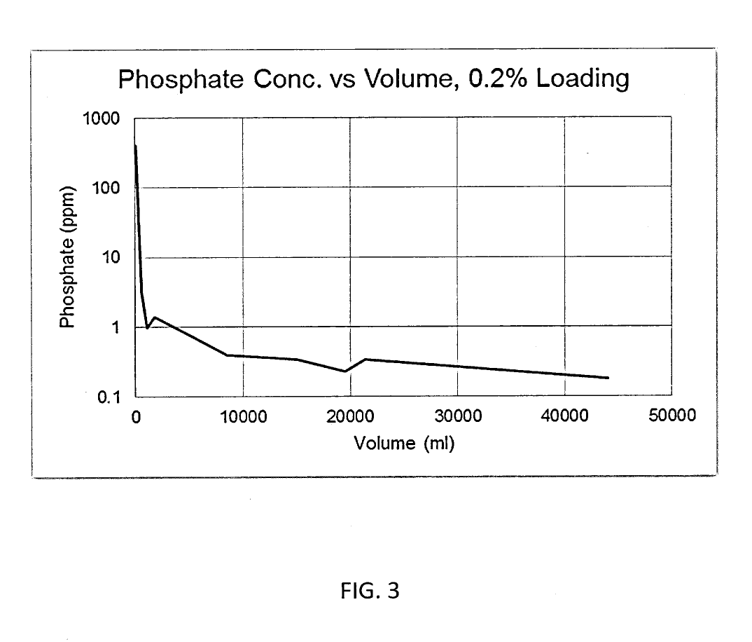

Example 2: Quantifying performance of gradual release of treatment chemical. A tote reservoir supplied brine solution to a series of filters. The effluent from the tote was piped through PVC tubing into a peristaltic pump which supplied a rate of 5 ml/min to each filter. The filters were fitted with tubing on each end such that the brine solution could be pumped into the inlet of the filter and exit through the outlet. Each filter was packed with 130 g of 20/40 Brady Sand containing 1%, 0.5%, and 0.2% by weight of the composite. The sand-composite mixtures were thoroughly mixed to ensure that the composite was dispersed evenly throughout the packed filter. Effluent from the outlet of the filters was collected frequently and analyzed for phosphate. As illustrated in FIGS. 1, 2, and 3 the phosphate levels were plotted against volume to obtain a time-dependent release profile of the composite. The phosphate levels maintain at 1 ppm for an extended amount of time indicating that the composite is effective in providing long term scale inhibition.

Example 3: Evaluation of resistance to crushing. Raw Corn grit and diatomaceous earth were each subject to crush resistance testing. The testing was performed in accordance to API RP-56 standard testing method to determine the amount of fines generated by the test. Raw material was first put through a sieve to obtain 100% 20/40 mesh size particles. 40 grams of 20/40 material was then placed into the crush cell and the piston placed inside. The piston was rotated 180 degrees and the crush cell was placed into a 20 ton shop press. A load of 5000 lbs was slowly applied onto the material. The material was then removed from the crush cell and placed into a sieve to determine the amount of fines generated. Corn grit displayed a far superior crush resistance when compared to diatomaceous earth.

Example 4: Creation of salt inhibitor composition. A bag of raw corn grit is placed at the opening of the elevator. A total of 2,000 lbs. of corn grit is added into the elevator and placed into the paddle mixer. A total of 1,400 lbs. of a polycarboxylic acid or similar salt inhibitor is then pumped from a tote and into the paddle mixer. About half way through the pumping process the dust collector can be turned off if the material inside is damp enough to not allow dust to escape the paddle mixer. Mixing continues until the material inside becomes flowable. One end of a conveyor belt is placed underneath the paddle mixer and turned on. An empty bulk bag is placed at the other end of the conveyor belt and the valve at the bottom of the paddle mixer is opened. When the bulk bag is almost full the valve is shut off and the full bag is replaced with an empty one and so on and so forth until the mixer is empty. A full bulk bag of treated corn grit is placed at the opening of the elevator. The full bulk bags of material are added to the elevator and into the hopper above the shaker. An empty bulk bag is placed at the discharge of the shaker screen and the shaker is turned on. The valve at the bottom of the hopper is slightly opened. The flow of the material is kept at a volume so that material doesn't continue to grow in volume on the top scalping screen and blind it off When the bulk bag is almost full the valve and the shaker are shut off and the full bulk bag is replaced with an empty one so that the hopper can be emptied through the shaker screen.

Example 5: Adding a blend of two or more liquid scale inhibitors to the substrate. Two unique chemical are blended in a tote prior to manufacturing the composition. Each chemical is designed to provide a specific function such as scale inhibition, corrosion inhibition, emulsion breaking, salt inhibition, clay stabilization, fines control, paraffin inhibition, and asphaltene inhibition. A bag of raw corn grit is placed at the opening of the elevator. A total of 2,000 lbs, of corn grit is added into the elevator and placed into the paddle mixer. A total of 1,400 lbs. of a previously mixed liquid blend is then pumped from a tote and into the paddle mixer. About half way through the pumping process the dust collector can be turned off if the material inside is damp enough to not allow dust to escape the paddle mixer. Mixing continues until the material inside becomes flowable. One end of a conveyor belt is placed underneath the paddle mixer and turned on. An empty bulk bag is placed at the other end of the conveyor belt and the valve at the bottom of the paddle mixer is opened. When the bulk bag is almost full the valve is shut off and the full bag is replaced with an empty one and so on and so forth until the mixer is empty. A full bulk bag of treated corn grit is placed at the opening of the elevator. The full bulk bags of material are added to the elevator and into the hopper above the shaker. An empty bulk bag is placed at the discharge of the shaker screen and the shaker is turned on. The valve at the bottom of the hopper is slightly opened. The flow of the material is kept at a volume so that material doesn't continue to grow in volume on the top scalping screen and blind it off. When the bulk bag is almost full the valve and the shaker are shut off and the full bulk bag is replaced with an empty one so that the hopper can be emptied through the shaker screen.

Example 6: Blending of two or more dry chemical compositions to create a multifunctional product. Two or more varieties of treated corn grit are combined and dry blended together in a ribbon or paddle mixer to make a multifunctional product or to enhance product performance.

Example 7: Blending of invented composition with one or more dry chemicals to create a multifunctional product. One or more varieties of treated corn grit are dry blended with additional dry chemicals in a ribbon or paddle mixer to make a multifunctional product or to enhance product performance.

What is claimed is:

1. An oil or gas well-treating composition comprising:
a first non-water-soluble carrier comprising corn grit, and a first active chemical agent adsorbed by the first non-water-soluble carrier;
wherein the first non-water-soluble carrier provides a controlled release of the first active chemical agent.

2. The composition of claim 1 wherein the controlled release provides about 12 months of continuous treatment.

3. The composition of claim 1, wherein the first non-water-soluble carrier is a natural milled or ground particulate from woody rings of corn cobs.

4. The composition of claim 1, wherein the first active chemical agent is designed to inhibit at least one of scale, corrosion, emulsions, salt formation, clay swelling, fine migration, paraffin, asphaltenes, biological growth, gels, or cross-linking.

5. The composition of claim 1, further comprising a second active chemical agent adsorbed by the first non-water-soluble carrier.

6. The composition of claim 5, wherein the first active chemical agent is a scale inhibitor and the second active chemical agent is a corrosion inhibitor.

7. A method of manufacturing the composition of claim 5 comprising the steps of:
first blending the first active chemical agent and the second active chemical agent as liquids in the same batch to form a blend;
then adsorbing the blend into the first non-water-soluble carrier.

8. The composition of claim 1 further comprising a second active chemical agent adsorbed by a second non-water-soluble carrier.

9. A method of making the composition of claim 8 comprising the steps of:
adsorbing the first active chemical agent into the first non-water-soluble carrier to form a first modified particulate;
adsorbing the second active chemical agent into the second non-water-soluble carrier to form a second modified particulate;
mixing the first modified particulate and the second modified particulate.

10. The composition of claim 1, where the composition is designed to provide wettability changes to a proppant pack and formation.

11. The composition of claim 1 wherein the composition is designed to lower the surface tension of water in an oil or gas well.

12. The composition of claim 1 wherein the composition is designed to deliver water- and oil-soluble tracers to fractures.

13. The composition of claim 1, wherein the composition provides a slow release of the first active chemical agent as it comes into contact with water in the oil or gas well.

14. The composition of claim 1 wherein the composition is designed to suppress an odor or malodor of the first active chemical agent.

15. The composition of claim 1, wherein the composition is designed to suppress an odor or malodor of one or more of scale inhibitors, corrosion inhibitors, emulsion breakers, salt inhibitors, clay stabilizers, fine control agents, paraffin inhibitors, asphaltene inhibitors, and dispersants.

16. A method for inhibiting scale in an oil or gas well by pumping into the well a composition comprising a non-water-soluble carrier comprising corn grit and an active chemical agent adsorbed into the non-water-soluble carrier.

17. The method of claim 16, wherein the composition is delivered as one of a fracture stimulation, a re-fracturing operation, a gravel pack, and a pre-packed screen containing the composition.

18. The method of claim 16, wherein the composition is pumped into the well with a proppant and a fracturing fluid matrix during a stimulation treatment.

19. The method of claim 17, wherein the composition is delivered as a pre-packed screen containing the composition.

20. A composition for treating oil or gas wells comprising:
a non-water-soluble carrier comprising corn grit, and
an active chemical agent adsorbed by the non-water-soluble carrier,
wherein the non-water-soluble carrier provides a controlled release of the active chemical agent.

21. The composition of claim 20 wherein the controlled release provides a slow release of the active chemical agent as it comes into contact with water in the oil or gas well to provide about 12 months of continuous treatment.

22. The composition of claim 20, wherein the non-water-soluble carrier is a natural milled or ground particulate from woody rings of corn cobs.

23. The composition of claim 20, wherein the active chemical agent is designed to inhibit at least one of scale, corrosion, emulsions, salt formation, clay swelling, fine migration, paraffin, asphaltenes, biological growth, cross-linking, or gelling.

24. The composition of claim 20, where the composition is designed to provide at least one of wettability changes to a proppant pack and formation, lower the surface tension of water in an oil or gas well, and water- and oil-soluble tracers to fractures.

25. The composition of claim 20, wherein the composition is designed to suppress an odor or malodor of one of more of scale inhibitors, corrosion inhibitors, emulsion breakers, salt inhibitors, clay stabilizers, fine control agents, paraffin inhibitors, asphaltene inhibitors, and dispersants.
